(19) United States
(12) Patent Application Publication
(10) Pub. No.: US 2015/0112813 A1
(43) Pub. Date: Apr. 23, 2015

(54) SYSTEM AND METHOD FOR PROVIDING A PRODUCT INVENTORY INFORMATION PLATFORM WITH STANDARDS VALIDATION

(71) Applicant: LeiLani Cauthen, Fair Oaks, CA (US)

(72) Inventor: LeiLani Cauthen, Fair Oaks, CA (US)

(21) Appl. No.: 14/514,281

(22) Filed: Oct. 14, 2014

Related U.S. Application Data
(60) Provisional application No. 61/961,549, filed on Oct. 18, 2013.

(51) Int. Cl. G06Q 30/02

(52) U.S. Cl. CPC G06Q 30/0269
USPC 705/14.66

(57) ABSTRACT

A system and method for providing a product inventory information platform with standards validation are disclosed. A particular embodiment is configured to: receive a first set of information from a plurality of product sources, the first set of information indicative of product availability from the plurality of product sources; receive a second set of information from a plurality of product consumers, the second set of information indicative of products obtained or needed by the plurality of product consumers; generate a plurality of profiles based on the first and second sets of information, the plurality of profiles including product source profiles and consumer profiles; perform at least one analysis operation on the plurality of profiles, the at least one analysis operation including comparing the product source profiles and consumer profiles to an applicable standard to identify gaps or conflicts between the product source profiles and consumer profiles relative to the applicable standard; and present results of the at least one analysis operation to a user.

### PRIORITY PATENT APPLICATION

This is a non-provisional patent application claiming priority to co-pending U.S. provisional patent application Ser. No. 61/961,549; filed on Oct. 18, 2013. This present non-provisional patent application draws priority from the referenced provisional patent application. The entire disclosure of the referenced patent application is considered part of the disclosure of the present application and is hereby incorporated by reference herein in its entirety.

### TECHNICAL FIELD

This patent application relates to computer-implemented software and networked systems, according to one embodiment, and more specifically to a system and method for providing a product inventory information platform with standards validation.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012-2014 The Learning Counsel, All Rights Reserved.

### BACKGROUND

Electronic information processing and communication systems are playing an increasingly important role in disseminating information, collaborating, and coordinating business operations, among various participants in a community (e.g., the learning community). Among other functions, these technologies may be utilized for coordinating administrative operations, disseminating information or documents for review and retention, providing individual or business access to media content and product information, providing reference and research libraries, and enabling information input for ongoing educational, legal, and other support and functions. Currently, these activities are disjoint and provided independently of each other. In addition, many vital services and activities as well as important procurement and/or reference information are not provided in an automated way. Publisher inventory is often kept in off line data storage and is cumbersome to review, compare, and disseminate. The lack of automation and central data storage makes it difficult to identify gaps in inventory and product offerings and makes it difficult or impossible to accomplish standards compliance.

### BRIEF DESCRIPTION OF THE DRAWINGS

The various embodiments are illustrated by way of example, and not by way of limitation, in the figures of the accompanying drawings in which:

FIG. 1 illustrates an example embodiment of a product inventory management system in a network-enabled environment;

FIG. 2 illustrates an example embodiment of the product inventory management system in the context of an educational or academic ecosystem;

FIG. 3 illustrates an example embodiment of the product inventory management system in a general producer/consumer implementation;

FIG. 4 is a processing flow chart illustrating an example embodiment of a method as described herein;

FIG. 5 illustrates another example embodiment of a networked system in which various embodiments may operate; and

FIG. 6 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for providing a product inventory information platform with standards validation are disclosed. The various embodiments enable a variety of data network-connected product producers or product sources to generate source profiles that describe the products and product categories each product source can provide. The various embodiments also enable a variety of data network-connected product consumers to generate consumer profiles that describe the products and product categories each product consumer already has or needs. The product sources can be manufacturers, vendors, distributors, aggregators, channel partners, or the like. The product consumers can be individual consumers or organizational consumers, such as businesses, institutions, government, or other organizations. The product consumers can be customers or prospects of the product sources. The products are typically things of an electronic or physical nature.

In various example embodiments described herein, the product inventory information platform can receive data input from the product sources and the product consumers via a data network. From the product sources, the product inventory information platform can receive their company information including product and/or product category details that specify the products or categories each product source has available. This information can be used to create product source profiles and sub-profiles for each product available from each of a plurality of product sources. The product source profiles can be aggregated across a plurality of product sources and retained in a network-accessible central data repository.

From the organizational product consumers, the product inventory information platform can receive company information including product inventory listings of their existing installed/used products and listings of any products the organizational product consumers want to acquire. This information can be used to create consumer profiles for each organizational product consumer. In a particular embodiment, the consumer profiles can be hierarchical in nature and may specify the product listings for any divisions, departments, or individuals of the organizational product consumer. The product consumer profiles can also be aggregated across a plurality of organizational product consumers and retained in the network-accessible central data repository.

From individual consumers, the product inventory information platform can receive personal information including personal histories and product inventory listings of existing installed/used products and listings of any products the individual consumers want to acquire. This information can be used to create consumer profiles for each individual consumer whether an individual, a client of an organizational consumer, or an employee or agent of an organizational consumer. The product consumer profiles can be aggregated across a plurality of individual consumers and retained in the network-accessible central data repository. Each of these profile types can be separable and can have different presentments upon completion, with different features depending on the type of profile.

Once the product source profiles and consumer profiles are created by any of the parties as described above and the profile data is retained in the network-accessible central data repository, the product inventory information platform can perform a variety of analysis and processing operations on the data. In a first general analysis operation, the product inventory information platform can compare the product source profiles against the consumer profiles to match the consumers needing a particular product with the product sources that have the particular product available. This product matching operation can be performed on the basis of a specific product or a product category. In a second general analysis operation, the product inventory information platform can compare the product source profiles against the consumer profiles to identify gaps or variances between the product supply available from the product sources and the product demand corresponding to the products used or needed by the product consumers. For example, the product inventory information platform can identify gaps associated with products available from the product sources, but not needed by the product consumers. Similarly, the product inventory information platform can identify gaps associated with products needed by the product consumers, but not available from the product sources. In other analysis operations, the product inventory information platform can perform a variety of comparisons between the product source profiles and the consumer profiles to identify variances, conflicts, trends, patterns, and other mathematically determinable results. Each of these analysis operations can be configured by a user with a set of analysis and filtering parameters to focus on the data sets and results of interest to the user. The analysis and filtering parameters can include time limiters, scoring, percentages, costs, and a variety of other configuration parameters. The analysis may be product-derived or user-derived. The analysis results or analytics can be presented via a user interface or via a plurality of reporting tools. The results can be presented as a grouped analysis or presented with different views based on the profiles.

In an example of the first general analysis operation, the product inventory information platform can present a listing of products matched between a particular product source and a particular consumer. The product inventory information platform can facilitate fulfillment of the product requests from the product consumers by providing links or other information to connect the consumer with the appropriate matched product source. In a particular embodiment, the product inventory information platform can also perform the actual commercial transaction between the consumer and the product source to complete the product purchase/sale.

In an example of the second general analysis operation, the product inventory information platform can present a listing of products, a listing of product categories, a listing of parties, or other information to identify the gaps or variances between the product supply and the product demand as described above. The product inventory information platform can be further configured to communicate with the product sources and consumers to notify the parties of the discovered gaps and offer or recommend options to rectify the product gaps.

The product inventory information platform of an example embodiment can also retrieve, retain, and process a set of standards, which can include information defining practices associated with industry accepted models and/or relevant legal requirements established under federal, state, or local laws. In many circumstances, the product inventories offered by product sources or used/requested by product consumers are subject to regulation or standard practice. In other circumstances, the context in which the products are offered or requested is subject to regulation or standard practice. For example, in a particular embodiment of the product inventory information platform in the context of an educational or academic ecosystem, the product inventories offered by product sources can represent educational materials, such as text books, references, teaching materials, and the like. These educational materials can be offered by product sources (e.g., publishers), who can sell these products to the product consumers (e.g., schools, school districts, faculty, or other educators, and students, etc.). In an unregulated system, the product buyers and sellers would be free to operate in any manner of their choosing; and an embodiment of the product inventory information platform as described above can facilitate this activity by matching product buyers with product sellers. However, in a regulated environment, such as the educational or academic ecosystem among others, product sources and product consumers must comply with the applicable regulations or standard practices. This additional layer of complexity is not addressed by conventional on-line marketplaces. In particular, the educational or academic ecosystem, is subject to a set of educational standards for educational excellence called the Common Core Curriculum (CCC) Standard, which has been adopted by forty-five states, the District of Columbia, four territories, and the Department of Defense Education Activity. Product sources have scrambled to determine if their product inventories meet the CCC standard. To further complicate standards compliance, non-aligned states and many local communities or school districts have standards of their own. These standards define requirements that must be met by grade, and so if facilitated by a digital curriculum product, help the institution/teacher/student meet those requirements. Educational products that facilitate compliance with the relevant standards can be marked by publishers or third parties. As described in more detail herein, the product inventory information platform of an example embodiment supports the interactions between product sources and product consumers with an added feature for applying applicable standards to these interactions and related commercial transactions. For example, again in the particular embodiment of the product inventory information platform in the context of an educational or academic ecosystem, the platform described herein can provide a first standards analysis operation, wherein the product inventory information platform can compare the product source profiles provided by product sources (e.g., publishers or vendors of educational materials) against the related provisions of the CCC standard. This comparison can produce a result that shows the standards gaps between the products available from a particular product source and the products required under the standard. Similarly, the product inventory information platform can compare the consumer profiles provided by product consumers (e.g., schools, districts, faculty, or other educators, students, etc.) against the related provisions of the CCC standard. This comparison can produce a result that shows the standards gaps between the products currently in use or requested by a particular product consumer and the products required under the standard. An example embodiment of the platform described herein can also provide a second standards analysis operation, wherein the product inventory information platform can compare the product source profiles and the consumer profiles together against the related provisions of the CCC standard. This comparison can produce a result that shows the standards gaps between the products required under the standard and the products currently offered by product sources and products in use or requested by a particular product consumer. In other analysis operations, the product inventory information platform can perform a variety of comparisons between the related provisions of the applicable standards and the product source profiles and the consumer profiles to identify variances, conflicts, trends, patterns, and other mathematically determinable results. Each of these standards analysis operations can be configured by a user with a set of analysis and filtering parameters to focus on the data sets or results of interest to the user. The standards analysis results or analytics can be presented via a user interface or via a plurality of reporting tools. The standards analysis results can be presented as a grouped analysis or presented with different views based on the profiles and/or the related standards.

In an example of the first standards analysis operation, the product inventory information platform can present a listing of products required under the standard, but not available from a particular product source. The product inventory information platform can also present a listing of products required under the standard, but not in use or requested by a particular product consumer. As a result, the various embodiments can identify standards gaps or variances between the product supply and the product demand based on an applicable standard. The product inventory information platform can be further configured to communicate with the product sources and consumers to notify the parties of the discovered standards gaps and offer or recommend options to rectify the standards gaps.

In another example embodiment of the product inventory information platform, the platform can be used in the context of a pharmaceutical or prescription drug ecosystem. In this case, the product inventories offered by product sources can represent pharmaceutical materials, such as prescription drugs, medications, medical supplies, and the like. These pharmaceutical materials can be offered by product sources (e.g., drug companies, vendors, medical supply distributors, channel partners, etc.), who can offer and sell these pharmaceutical products to the product consumers (e.g., pharmacists, physicians, pharmacies, hospitals, medical facilities, individuals, etc.). In the regulated pharmaceutical environment, product sources and product consumers must comply with the applicable regulations and/or standard practices. In particular, the pharmaceutical or prescription drug ecosystem is subject to a set of federal, state, and local laws and a set of pharmaceutical standards that define hazardous drug interactions. Again in the context of a pharmaceutical or prescription drug ecosystem, an example embodiment of the platform described herein can provide a standards analysis operation, wherein the product inventory information platform can compare the product source profiles and the consumer profiles against the related provisions of the relevant pharmaceutical standards. This comparison can produce a result that can show the potential hazardous drug interaction conflicts between the pharmaceutical products currently offered by product sources and/or products in use or requested by a particular product consumer. In other analysis operations, the product inventory information platform can perform a variety of comparisons between the related provisions of the applicable pharmaceutical standards, the product source profiles, and the consumer profiles to identify variances, conflicts, trends, patterns, and other mathematically determinable results. The standards analysis results or analytics can be presented via a user interface or via a plurality of reporting tools. The standards analysis results can be presented as a grouped analysis or presented with different views based on the profiles and/or the related pharmaceutical standards. As a result, the various embodiments can identify standards gaps, variances, and/or conflicts between the product supply and the product demand based on an applicable pharmaceutical standard. The product inventory information platform can be further configured to communicate with the product sources and consumers to notify the parties of the discovered standards gaps or conflicts and offer or recommend options to rectify the standards gaps or conflicts. It will be apparent to those of ordinary skill in the art in view of the disclosure herein that the functionality of various embodiments of the product inventory information platform as described herein can be used in a variety of other ecosystems or applications.

In the example embodiment described herein, the product inventory information platform also operates as a social networking platform to enable communication, collaboration, and sharing among authorized users. As such, any user, with or without a full profile, may opt to search through all product listings and obtain customized search results and presentment of data from the completed profiles. Users can communicate with other authorized users through the product inventory information platform and may share profiles or certain data sets depending on settings. Users also have the capability of posting announcements of a product purchase or product request to all users or a sub-set of users of the product inventory information platform community.

The product inventory information platform of various embodiments as described herein provides several advantages. A few of these advantages include: 1) more than one type of profile can be user-generated; 2) profiles can be compared against each other to identify gaps or variances; 3) profiles can be compared against applicable standards to identify standards gaps or variances; 4) analysis results can be presented to the user in a variety of configurable views or reports; and 5) the product inventory information platform can facilitate product fulfillment in view of the identified gaps or variances.

The product inventory information platform of various embodiments has utility in a variety of different markets, ecosystems, or applications. In one example embodiment described herein, an implementation of the platform can be used in the context of an education or academic ecosystem. In this case, publishers operate as product sources of educational content or materials for the consumers represented by schools, districts, faculty, or other educators, and students. The standards in this example can correspond to the CCC standards as explained above. It will be apparent to those of ordinary skill in the art in view of the disclosure herein that the functionality of various embodiments of the product inventory information platform as described herein can be used with a variety of other standards as well. As described above, the product inventory information platform of various embodiments can apply analysis operations to the publisher profiles and consumer profiles in view of the CCC standards to identify standards gaps, variances, and conflicts, which can be communicated to users via a user interface or via various reporting mechanisms.

In another example embodiment described herein, an implementation of the platform can be used in the context of a pharmaceutical or prescription drug ecosystem. In this case, drug companies or other product suppliers/vendors operate as product sources of pharmaceuticals, prescription drugs, or medical supplies for the consumers represented by pharmacists, physicians, pharmacies, hospitals, medical facilities, individuals, etc. The standards in this example correspond to the set of federal, state, and local laws and pharmaceutical standards that define hazardous drug interactions as explained above. As described above, the product inventory information platform of various embodiments can apply standards analysis operations to the drug company profiles and consumer profiles in view of the pharmaceutical standards to identify standards gaps, variances, and conflicts, which can be communicated to users via a user interface or via various reporting mechanisms.

In various embodiments described in detail herein, a software application program is used to gather, process, and distribute product information, product source information, and consumer information, including profile data, using a computer system, a web appliance, and/or a mobile device. As described in more detail herein, the computer or computing system on which the described embodiments can be implemented can include personal computers (PCs), portable computing devices, laptops, tablet computers, personal digital assistants (PDAs), wearable computing devices, personal communication devices (e.g., cellular telephones, smartphones, or other wireless devices), network computers, set-top boxes, consumer electronic devices, or any other type of computing, data processing, communication, networking, or electronic system.

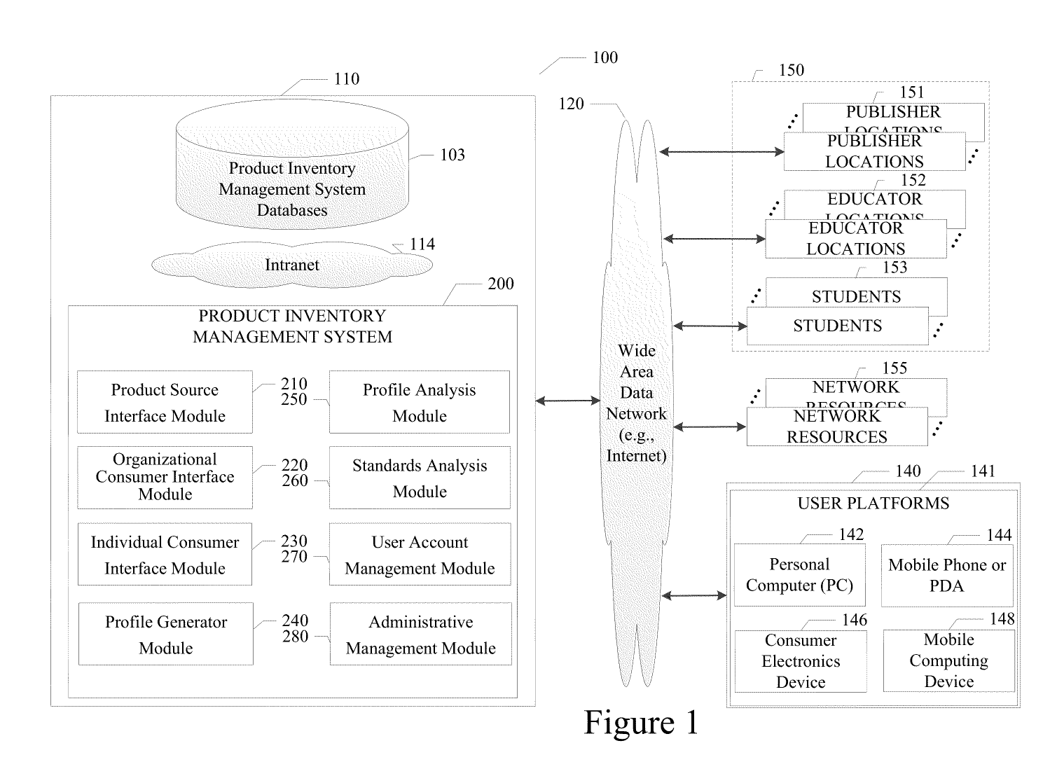

Referring now to FIG. 1, in an example embodiment, a system for product inventory management 100 in a network-enabled environment is disclosed. In various example embodiments, an application or service, typically provided by or operating on a host site (e.g., a website) 110, is provided to simplify and facilitate the downloading or hosted use of the product inventory management system 200 of an example embodiment. In a particular embodiment, the product inventory management system 200, or a portion thereof, can be downloaded from the host site 110 by a user at a user platform 140. Alternatively, the product inventory management system 200 can be hosted by the host site 110 for a networked user at a user platform 140. The details of the product inventory management system 200 of an example embodiment are provided below.

Referring again to FIG. 1, the product inventory management system 200 can be in network communication with a plurality of user platforms 140. The host site 110 and user platforms 140 may communicate and transfer data and information in the data network environment 100 shown in FIG. 1 via a wide area data network (e.g., the Internet) 120. Various components of the host site 110 can also communicate internally via a conventional intranet or local area network (LAN) 114.

In an example embodiment, the product inventory management system 200 can also be in network communication with a plurality of client locations 150 and a plurality of network resources 155. Client locations 150 can represent the network locations of clients or client computing systems being managed by product sources or product consumers using an embodiment described herein. For example, in a particular embodiment of the product inventory information platform in the context of an educational or academic ecosystem as shown in FIG. 1, client locations 150 can represent the network locations of clients or client computing systems of publishers 151, educators 152, or students 153. In an alternative embodiment of the product inventory information platform in the context of a pharmaceutical or prescription drug ecosystem, client locations 150 can represent the network locations of clients or client computing systems of drug companies, pharmacies, or patients. Network resources 155 can represent the network locations of sources of information related to various applicable standards, third party contacts, affiliates, information sources, or other contacts or network resources that may provide or consume data associated with the product inventory management system 200 of the example embodiment.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through an Ethernet port or a universal serial bus (USB) port, other forms of computer-readable media, or any combination thereof. On an interconnected set of LANs, including those based on differing architectures and protocols, a router and/or gateway device can act as a link between LANs, enabling messages to be sent between computing devices. Also, communication links within LANs may include optical fiber data lines, twisted wire pairs or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), optical fiber, wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to be moved freely and randomly and to organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The product inventory management system can be implemented using any form of network transportable digital data. The network transportable digital data can be transported in any of a group of data packet or file formats, protocols, and associated mechanisms usable to enable a host site 110 and a user platform 140 to transfer data over a network 120. In one embodiment, the data format for the user interface can be HyperText Markup Language (HTML). HTML is a common markup language for creating web pages and other information that can be displayed in a web browser. In another embodiment, the data format for the user interface can be Extensible Markup Language (XML). XML is a markup language that defines a set of rules for encoding interfaces or documents in a format that is both human-readable and machine-readable. In another embodiment, a JSON (JavaScript Object Notation) format can be used to stream the interface content to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML. The Hypertext Transfer Protocol (HTTP) or secure HTTP (HTTPS) can be used as a network data communication protocol.

In a particular embodiment, a user platform 140 with one or more client devices 141 enables a user to access data and provide data and/or instructions for the product inventory management system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., Twitter), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

As one option, the product inventory management system 200, or a portion thereof, can be downloaded to a user device 141 of user platform 140 and executed locally on a user device 141. The downloading of the product inventory management system 200 application (or a portion thereof) can be accomplished using conventional software downloading functionality. As a second option, the product inventory management system 200 can be hosted by the host site 110 and executed remotely, from the user's perspective, on host system 110. In one embodiment, the product inventory management system 200 can be implemented as a service in a service-oriented architecture (SOA) or in a Software-as-a-Service (SAAS) architecture. In any case, the functionality performed by the product inventory management system 200 is as described herein, whether the application is executed locally or remotely, relative to the user.

Referring again to FIG. 1, the host site 110 of an example embodiment is shown to include a product inventory management system database 103. The network-accessible central database 103 is used in an example embodiment for data storage of information related to products, product inventories, product sources, product consumers, product source profiles, consumer profiles, information associated with relevant standards, configuration data, scheduling data, reporting data, and the like. Database 103 can be in data communication with the product inventory management system 200 directly or via intranet 114. It will be apparent to those of ordinary skill in the art that the database 103 can represent multiple datasets and can be used for the storage of a variety of data in support of the product inventory management system 200 of an example embodiment.

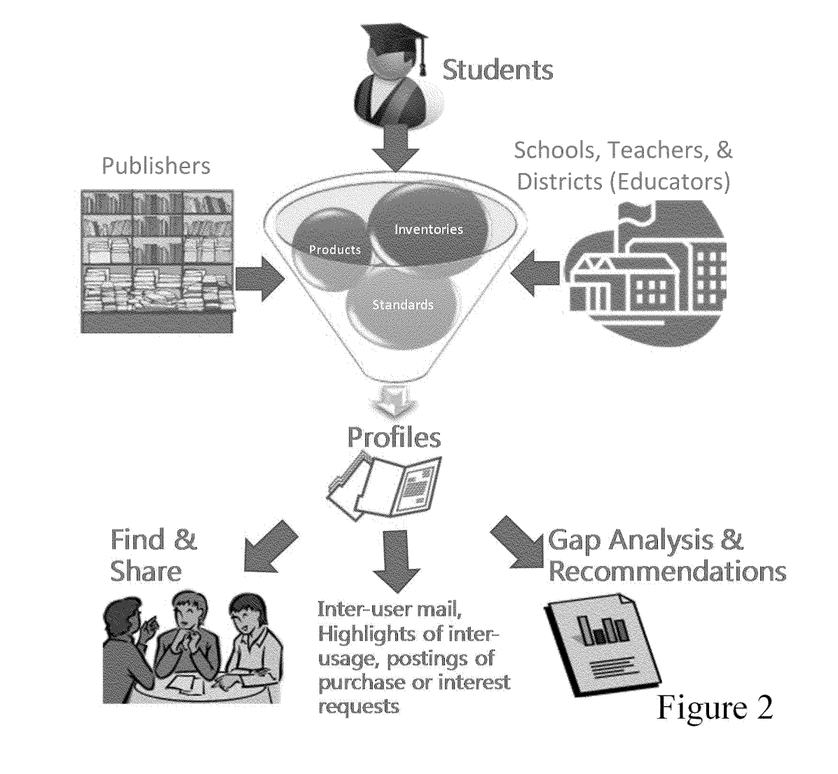

Referring now to FIG. 2, the diagram illustrates an example embodiment of the product inventory management system 200 in the context of an educational or academic ecosystem. In this context, the example embodiment provides a design for matching learning content to students, teachers and schools in view of relevant standards and other elements. In this case, as shown in FIG. 2, the product inventories offered by product sources (e.g., publishers, educational material vendors, etc.) can represent educational materials, such as text books, references, teaching materials, and the like. These educational materials can be offered by product sources, who can offer or sell these products to the product consumers (e.g., schools, school districts, faculty, or other educators, students, etc.). The organizational product consumers can represent the educators (e.g., schools, school districts, faculty, etc.) who serve as educational product consumers. The individual product consumers can represent the students or other individual consumers of educational products. The product sources and product consumers can generate profiles that define inventories of products that are available from the product sources or in use or needed by the product consumers. Both product sources (e.g., publishers or educational material vendors, etc.) and product consumers (e.g., schools, etc.) can use the product inventory management system 200 to find learning content and curriculum. In addition, the product sources and consumers can create profiles of either products or school district/teacher/student inventory. As a result, the product inventory management system 200 can retain information detailing available publisher products and product inventories owned/used by students, teachers and schools. In a regulated environment, such as the educational or academic ecosystem, product sources and product consumers must comply with the applicable regulations or standard practices, such as the CCC standard as described above. As described in more detail herein, the product inventory information platform of an example embodiment supports the interactions and commercial transactions between product sources and product consumers with an added feature for applying applicable standards analysis to these interactions. The product inventory information platform of an example embodiment can compare the product source profiles and the consumer profiles against the related provisions of the CCC standard. This comparison can produce a result that shows the standards gaps between the products required under the standard and the products currently offered by product sources and product inventories in use or requested by a particular product consumer. In other analysis operations, the product inventory information platform can perform a variety of comparisons between the related provisions of the applicable standards and the product source profiles and the consumer profiles to identify variances, conflicts, trends, patterns, and other mathematically determinable results. The analysis results or analytics can be presented via a user interface or via a plurality of reporting tools. The product inventory information platform can be further configured to communicate with the product sources and consumers to notify the parties of the discovered standards gaps and offer options or recommendations to rectify the standards gaps.

As also shown in FIG. 2, the product inventory information platform of an example embodiment also operates as a social networking platform to enable communication, collaboration, and sharing among authorized users. As such, any user, with or without a full profile, may opt to search through all products and obtain customized search results and presentment of data from the completed profiles. Users can communicate with other authorized users and may share profiles or certain data sets depending on settings. Users also have the capability of posting announcements of a product purchase or product request to all or a sub-set of users.

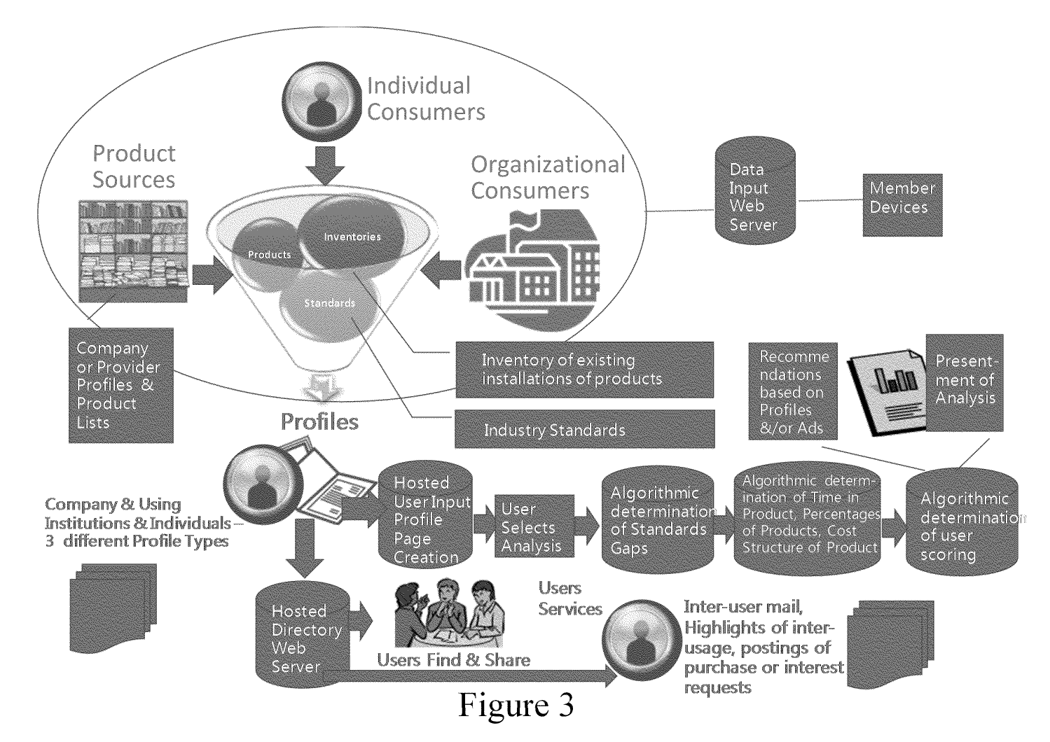

Referring now to FIG. 3, the diagram illustrates an example embodiment of the product inventory management system in a general producer/consumer implementation. The various embodiments enable a variety of data network-connected product producers or product sources to generate profiles and product lists that describe the products and product categories each product source can provide. The product sources can be manufacturers, vendors, distributors, aggregators, channel partners or the like. The various embodiments also enable a variety of data network-connected product consumers to generate profiles that describe the product inventories and product categories each product consumer already has installed or needs. The product consumers can be individual consumers or organizational consumers, such as businesses, institutions, government, or other organizations. The product consumers can be customers or prospects of the product sources.

Given the variations in the types of product sources and consumers, the product inventory management system maintains a variety of different types of profiles. In a particular embodiment, at least three profile types are supported: product source profiles, organizational consumer profiles, and individual consumer profiles. It will be apparent to those of ordinary skill in the art in view of the disclosure herein that a variety of different types of profiles can be supported in various embodiments. As also shown in FIG. 3 and described above, the example embodiment of the product inventory management system can retain information pertaining to one or more relevant industry standards, which can be used in the analysis of the profiles.

Referring still to FIG. 3 for various example embodiments, the product inventory information platform can receive data input, including profile information, from the product sources and the product consumers via a data network. Once the product source profiles and consumer profiles are created by any of the parties as described above and the profile data is retained in the network-accessible central data repository, the product inventory information platform can perform a variety of user-selectable analysis and processing operations on the data. In a particular analysis operation, the product inventory information platform can generate analysis results showing product summaries, totals and detail by product category, totals and details by price or cost, totals and details by product source or availability, totals and details by product quantities, and a variety of other product metrics. Scorings and rankings of products in a variety of dimensions can then be automatically generated from the analysis results. In another analysis operation, the product inventory information platform can compare the product source profiles against the consumer profiles to identify gaps or variances between the product supply available from the product sources and the product demand corresponding to the products needed by the product consumers. Summaries or details of these gaps or variances can also be presented to the user. Additionally, in another analysis operation, the product inventory information platform can compare the product source profiles and the consumer profiles against relevant standards to identify standards gaps or variances between the product supply available, the product demand, and the requirements of the relevant standards. Summaries or details of these standards gaps or variances can also be presented to the user. The product inventory information platform can be further configured to communicate with the product sources and consumers to notify the parties of the discovered standards gaps and offer options or recommendations to rectify the standards gaps.

As also shown in FIG. 3, the product inventory information platform of an example embodiment also operates as a social networking platform to enable communication, collaboration, and sharing among authorized users. As such, any user, with or without a full profile, may opt to search through all products and obtain customized search results and presentment of data from the completed profiles. Users can communicate with other authorized users and may share profiles or certain data sets depending on settings. Users also have the capability of posting announcements of a product purchase or product request to all or a sub-set of users.

Referring again to FIG. 1, host site 110 of an example embodiment is shown to include the product inventory management system 200. Product inventory management system 200 can include a Product Source Interface Module 210, an Organizational Consumer Interface Module 220, an Individual Consumer Interface Module 230, a Profile Generator Module 240, a Profile Analysis Module 250, a Standards Analysis Module 260, a User Account Management module 270, and an Administrative Management module 280. Each of these modules can be implemented as software components executing within an executable environment of product inventory management system 200 operating wholly or in part on host site 110 or user platform 140. Each of these modules of an example embodiment is described in more detail below in connection with the figures provided herein.

Referring again to FIG. 1, the product inventory management system 200 of an example embodiment is shown to include a Product Source Interface Module 210. The Product Source Interface Module 210 is responsible for receiving input from a user or a network-connectible device corresponding to a product source and for displaying analysis results to a product source via any of the user interface platforms 141 described above. From the product sources, the Product Source Interface Module 210 can receive their company information including product and/or product category details that specify the products or categories each product source has available. This information can be used to create product source profiles and sub-profiles for each product available from each of a plurality of product sources. The product source profiles can be aggregated across a plurality of product sources and retained in a network-accessible central data repository 103.

Referring again to FIG. 1, the product inventory management system 200 of an example embodiment is shown to include an Organizational Consumer Interface Module 220. The Organizational Consumer Interface Module 220 is responsible for receiving input from a user or a network-connectible device corresponding to an organizational consumer and for displaying analysis results to an organizational consumer via any of the user interface platforms 141 described above. From the organizational product consumers, the Organizational Consumer Interface Module 220 can receive company information, product inventory listings of their existing installed/used products and listings of any products the organizational product consumers want to acquire. This information can be used to create consumer profiles for each organizational product consumer. The product consumer profiles can also be aggregated across a plurality of organizational product consumers and retained in the network-accessible central data repository 103.

Referring again to FIG. 1, the product inventory management system 200 of an example embodiment is shown to include an Individual Consumer Interface Module 230. The Individual Consumer Interface Module 230 is responsible for receiving input from an individual consumer or a network-connectible device and for displaying analysis results to the individual consumer via any of the user interface platforms 141 described above. From individual consumers, the Individual Consumer Interface Module 230 can receive personal information including personal histories and inventory listings of existing installed/used products and listings of any products the individual consumers want to acquire. This information can be used to create consumer profiles for each individual consumer whether an individual, a client of an organizational consumer, or an employee or agent of an organizational consumer. The product consumer profiles can be aggregated across a plurality of individual consumers and retained in the network-accessible central data repository 103.

Referring again to FIG. 1, the product inventory management system 200 of an example embodiment is shown to include a Profile Generator Module 240. The Profile Generator Module 240 is responsible for assisting users to create profiles and retain the profiles in the database 103 based on information received via the user interfaces described above. In various embodiments, there are a plurality of different types of profiles generated by various embodiments. In a particular embodiment, at least three profile types are supported: product source profiles, organizational consumer profiles, and individual consumer profiles. In other embodiments, the profiles are different for each type of user, such as representatives from schools or faculty or students themselves. In a particular embodiment, profiles can be hierarchical in nature and may specify the product listings for any divisions, departments, or individuals of the organizational product consumer. A master administrator responsible for the overall organizational persona of a district or school can have access rights to higher levels of the profile hierarchy, while all employees or individuals of the organization are automatically placed in a directory within the profile hierarchy and allowed to make their own profiles. It will be apparent to those of ordinary skill in the art in view of the disclosure herein that a variety of different types of profiles can be supported in various embodiments.

The product source or publisher profiles can be generated on two levels: company information and individual product data with features for that one product. The bifurcation of the product source profiles enables search functions to provide search-by-company, search-by-product, or search-by-feature options. A particular embodiment also allows for searching-by-standards. Teachers, schools, and districts are also able to upload, or check-off from lists, their own inventory and thus have a running record of all products to which they have access, own, use, or have installed. In so doing, consumers can self-activate termination alerts for when a product is end-of-life or a subscription is about to expire so that they can renew it.

Referring again to FIG. 1, the product inventory management system 200 of an example embodiment is shown to include a Profile Analysis Module 250. Once the product source profiles and consumer profiles are created by any of the parties as described above and the profile data is retained in the network-accessible central data repository 103, the Profile Analysis Module 250 can perform a variety of analysis and processing operations on the data. In a first general analysis operation, the Profile Analysis Module 250 can compare the product source profiles against the consumer profiles to match the consumers needing a particular product with the product sources that have the particular product available. This product matching operation can be performed on the basis of a specific product or a product category. In a second general analysis operation, the Profile Analysis Module 250 can compare the product source profiles against the consumer profiles to identify gaps or variances between the product supply available from the product sources and the product demand corresponding to the products used or needed by the product consumers. For example, the Profile Analysis Module 250 can identify gaps associated with products available from the product sources, but not needed by the product consumers. Similarly, the Profile Analysis Module 250 can identify gaps associated with products needed by the product consumers, but not available from the product sources. In other analysis operations, the Profile Analysis Module 250 can perform a variety of comparisons between the product source profiles and the consumer profiles to identify variances, conflicts, trends, patterns, and other mathematically determinable results. Each of these analysis operations can be configured by a user with a set of analysis and filtering parameters to focus on the data sets and results of interest to the user. The analysis results or analytics can be presented via a corresponding user interface or via a plurality of reporting tools. The results can be presented as a grouped analysis or presented with different views based on the profiles. In an example of the first general analysis operation, the Profile Analysis Module 250 can present a listing of products matched between a particular product source and a particular consumer. In an example of the second general analysis operation, the Profile Analysis Module 250 can present a listing of products, a listing of parties, or other information to identify the gaps or variances between the product supply and the product demand. The Profile Analysis Module 250 can be further configured to communicate with the product sources and consumers to notify the parties of the discovered gaps and offer options or recommendations to rectify the product gaps.

Referring again to FIG. 1, the product inventory management system 200 of an example embodiment is shown to include a Standards Analysis Module 260. As described above, the product inventory information platform of an example embodiment can retrieve, retain, and process a set of standards, which can include information defining practices associated with industry accepted models and/or relevant legal requirements established under federal, state, or local laws. In an example embodiment, the Standards Analysis Module 260 can provide a first standards analysis operation, wherein the module 260 can compare the product source profiles provided by product sources against the related provisions of an applicable standard. This comparison can produce a result that shows the standards gaps between the products available from a particular product source and the products required under the standard. Similarly, the Standards Analysis Module 260 can compare the consumer profiles provided by product consumers against the related provisions of the applicable standard. This comparison can produce a result that shows the standards gaps between the products currently in use or requested by a particular product consumer and the products required under the standard. An example embodiment of the Standards Analysis Module 260 described herein can also provide a second standards analysis operation, wherein the Standards Analysis Module 260 can compare the product source profiles and the consumer profiles together against the related provisions of the applicable standard. This comparison can produce a result that shows the standards gaps between the products required under the standard and the products currently offered by product sources and products in use or requested by a particular product consumer. In other analysis operations, the Standards Analysis Module 260 can perform a variety of comparisons between the related provisions of the applicable standards and the product source profiles and the consumer profiles to identify variances, conflicts, trends, patterns, and other mathematically determinable results. Each of these analysis operations can be configured by a user with a set of analysis and filtering parameters to focus on the data sets or results of interest to the user. The analysis results or analytics can be presented via a corresponding user interface or via a plurality of reporting tools. The results can be presented as a grouped analysis or presented with different views based on the profiles and/or the related standards. In an example of the first standards analysis operation, the Standards Analysis Module 260 can present a listing of products required under the standard, but not available from a particular product source. The Standards Analysis Module 260 can also present a listing of products required under the standard, but not in use or requested by a particular product consumer. As a result, the various embodiments can identify standards gaps or variances between the product supply and the product demand based on an applicable standard. The Standards Analysis Module 260 can be further configured to communicate with the product sources and consumers to notify the parties of the discovered standards gaps and offer options or recommendations to rectify the standards gaps.

Referring again to FIG. 1 and as described above, a user platform 141 can include a mobile device on which a mobile application (app) can be executed. An example embodiment 400, implemented as a mobile device app, can be used to support a mobile device user interface for the product inventory management system 200 of an example embodiment. It will be apparent to those of ordinary skill in the art that other embodiments can also be implemented as a web application (app) with one or more webpages or other types of user interfaces. A mobile version of an example embodiment provides a user-friendly interface from which the user can easily view the relevant client information from a mobile device. As described in more detail herein, a mobile software application (app) embodying a mobile version of an example embodiment as described herein can be installed and executed on a mobile device, such as a smart phone, laptop computer, tablet device, or the like. In an example embodiment, a splash screen appears whenever the user opens or launches the mobile application on the mobile device. This splash screen can display a host logo and wallpaper image while opening the login screen or a live feed of processed client information.

User log-in functionality in the mobile app provides a user-friendly user interface in which the user can provide an email address and password associated with the user account. If the user does not have an account, the user can create an account from this user interface. The process of creating a user account in an example embodiment is simple and only requires the user to provide the following information: name, surname, e-mail address, and password. By completing this information, the user can create an account and get access to processed client information.

Referring again to FIG. 1, the product inventory management system 200 of an example embodiment is also shown to include a user account management module 270. The user account management module 270 can be used to create and maintain a user account on the host site 110. The user account management module 270 can also be used to configure user settings, create and maintain a user/user profile on host site 110, and otherwise manage user data and operational parameters on host site 110. In the example embodiment described herein, a user can register as an identified user in order to share profiles, information, documents, communications, or other content. The registered user can enter their name, email address, and password. Once this information is entered, a user account is created and the user can share profiles, information, documents, communications, or other content.

Referring again to FIG. 1, the product inventory management system 200 of an example embodiment is shown to include an administrative management module 280. The administrative management module 280 can be used by an agent or administrator of the product inventory management system 200 to manage user accounts and to manage the product inventory management system. The administrative management module 280 can also be used to enforce privacy protections and content controls for users. Moreover, the administrative management module 280 can also be used to generate and/or process a variety of analytics associated with the operation of the product inventory management system 200. For example, the administrative management module 260 can generate various statistical models that represent the activity of the community of users and related product sources, product consumers, agents, affiliates, and the like. These analytics can be shared, licensed, or sold to others.

Although the various user interface displays provided by the example embodiments described herein are nearly infinitely varied, the descriptions of the user interface displays and sequences are provided herein to describe various features of the disclosed embodiments. These user interface displays and sequences are described herein with reference to example embodiments. It will be apparent to those of ordinary skill in the art that equivalent user interface displays and sequences can be implemented within the scope of the inventive subject matter disclosed and claimed herein.

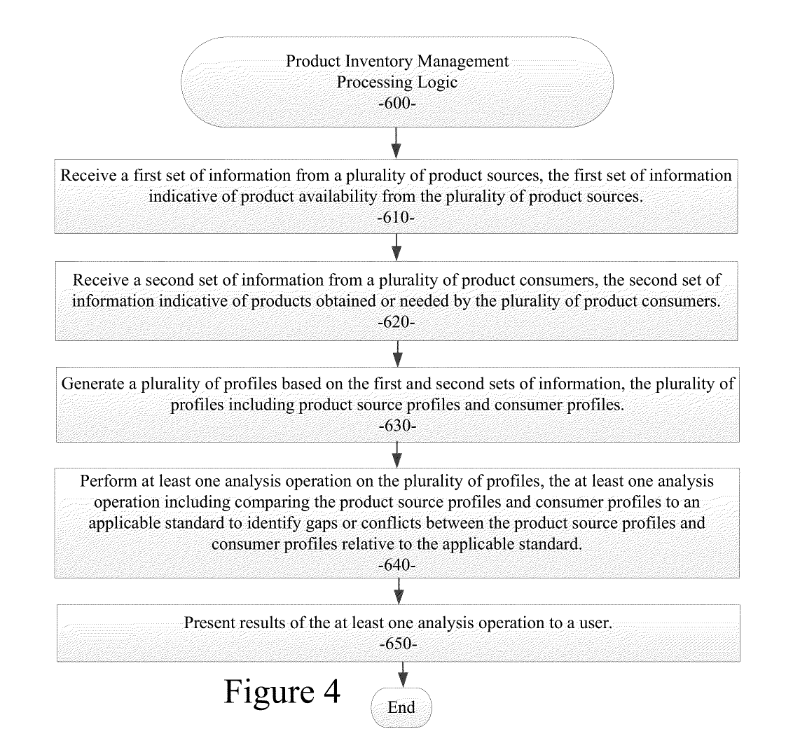

Referring now to FIG. 4, a processing flow diagram illustrates an example embodiment of a product inventory management system 200 as described herein. The method 600 of an example embodiment is configured to: receive a first set of information from a plurality of product sources, the first set of information indicative of product availability from the plurality of product sources (processing block 610); receive a second set of information from a plurality of product consumers, the second set of information indicative of products obtained or needed by the plurality of product consumers (processing block 620); generate a plurality of profiles based on the first and second sets of information, the plurality of profiles including product source profiles and consumer profiles (processing block 630); perform at least one analysis operation on the plurality of profiles, the at least one analysis operation including comparing the product source profiles and consumer profiles to an applicable standard to identify gaps or conflicts between the product source profiles and consumer profiles relative to the applicable standard (processing block 640); and present results of the at least one analysis operation to a user (processing block 650).

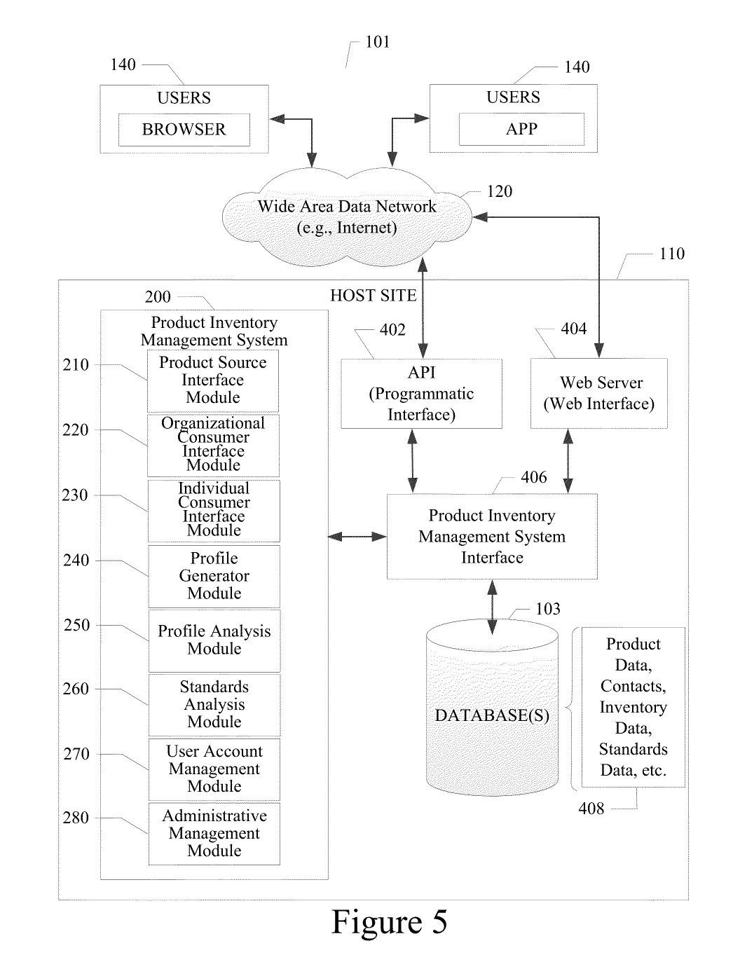

Referring now to FIG. 5, another example embodiment 101 of a networked system in which various embodiments may operate is illustrated. In the embodiment illustrated, the host site 110 is shown to include the product inventory management system 200. The product inventory management system 200 is shown to include the functional components 210 through 280, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the product inventory management system 200 either directly or via an interface 406. The product inventory management system 200 may be configured to access a data storage device 103 and data 408 therein either directly or via the interface 406.

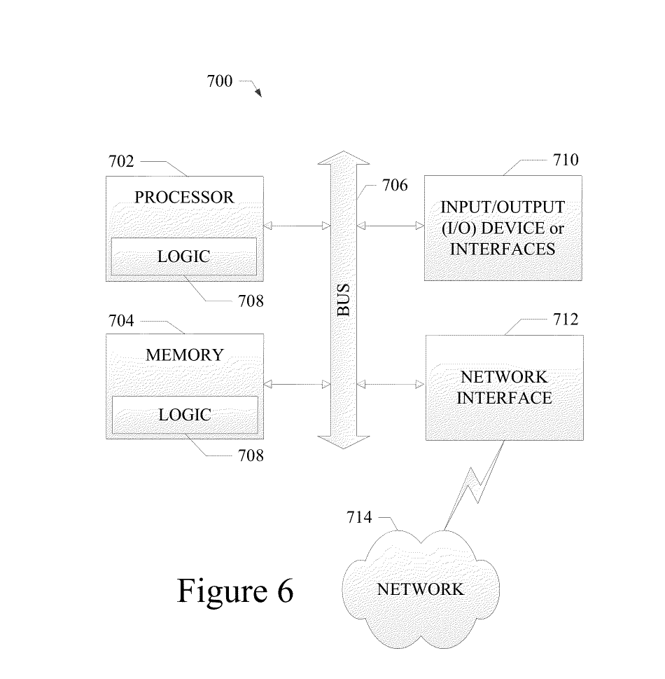

FIG. 6 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
receiving, via one or more user interface platforms, a first set of information from a plurality of product sources, the first set of information indicative of product availability from the plurality of product sources;
receiving, via one or more user interface platforms, a second set of information from a plurality of product consumers, the second set of information indicative of products obtained or needed by the plurality of product consumers;
generating, by a data processor, a plurality of profiles based on the first and second sets of information, the plurality of profiles including product source profiles and consumer profiles;
performing at least one analysis operation on the plurality of profiles, the at least one analysis operation including comparing the product source profiles and consumer profiles to an applicable standard to identify gaps or conflicts between the product source profiles and consumer profiles relative to the applicable standard; and
presenting results of the at least one analysis operation to a user.

2. The method as claimed in claim 1 wherein the plurality of product sources includes a publisher of educational materials.

3. The method as claimed in claim 1 wherein the plurality of product consumers includes an organizational consumer from the group consisting of: a school, a school district, a faculty representative, and an educator.

4. The method as claimed in claim 1 wherein the applicable standard is at least a portion of the Common Core Curriculum (CCC) Standard.

5. The method as claimed in claim 1 further including performing a first general analysis operation by comparing the product source profiles against the consumer profiles to match the product consumers needing a particular product with the product sources that have the particular product available.

6. The method as claimed in claim 1 further including performing a second general analysis operation by comparing the product source profiles against the consumer profiles to identify gaps or variances between a product supply available from the product sources and a product demand corresponding to products used or needed by the product consumers.

7. The method as claimed in claim 1 wherein generating, by a data processor, a plurality of profiles based on the first and second sets of information further including generating different types of profiles for the product sources and the product consumers.

8. The method as claimed in claim 1 further including facilitating product fulfillment in view of the identified gaps or conflicts.

9. The method as claimed in claim 1 further including presenting results of the at least one analysis operation to a user in a variety of configurable views or reports.

10. A system comprising:
a data processor;
a network interface, in data communication with the data processor, for communication on a data network; and
a product inventory management system, executable by the data processor, to:
receive a first set of information from a plurality of product sources, the first set of information indicative of product availability from the plurality of product sources;
receive a second set of information from a plurality of product consumers, the second set of information indicative of products obtained or needed by the plurality of product consumers;
generate a plurality of profiles based on the first and second sets of information, the plurality of profiles including product source profiles and consumer profiles;
perform at least one analysis operation on the plurality of profiles, the at least one analysis operation including comparing the product source profiles and consumer profiles to an applicable standard to identify gaps or conflicts between the product source profiles and consumer profiles relative to the applicable standard; and
present results of the at least one analysis operation to a user.

11. The system as claimed in claim 10 wherein the plurality of product sources includes a publisher of educational materials.

12. The system as claimed in claim 10 wherein the plurality of product consumers includes an organizational consumer from the group consisting of: a school, a school district, a faculty representative, and an educator.

13. The system as claimed in claim 10 wherein the applicable standard is at least a portion of the Common Core Curriculum (CCC) Standard.

14. The system as claimed in claim 10 being further configured to perform a first general analysis operation by comparing the product source profiles against the consumer profiles to match the product consumers needing a particular product with the product sources that have the particular product available.

15. The system as claimed in claim 10 being further configured to perform a second general analysis operation by comparing the product source profiles against the consumer profiles to identify gaps or variances between a product supply available from the product sources and a product demand corresponding to products used or needed by the product consumers.

16. The system as claimed in claim 10 being further configured to generate different types of profiles for the product sources and the product consumers.

17. The system as claimed in claim 10 being further configured to facilitate product fulfillment in view of the identified gaps or conflicts.

18. The system as claimed in claim 10 being further configured to present results of the at least one analysis operation to a user in a variety of configurable views or reports.

19. A non-transitory machine-useable storage medium embodying instructions which, when executed by a machine, cause the machine to:
receive a first set of information from a plurality of product sources, the first set of information indicative of product availability from the plurality of product sources;
receive a second set of information from a plurality of product consumers, the second set of information indicative of products obtained or needed by the plurality of product consumers;
generate a plurality of profiles based on the first and second sets of information, the plurality of profiles including product source profiles and consumer profiles;
perform at least one analysis operation on the plurality of profiles, the at least one analysis operation including comparing the product source profiles and consumer profiles to an applicable standard to identify gaps or conflicts between the product source profiles and consumer profiles relative to the applicable standard; and
present results of the at least one analysis operation to a user.

20. The machine-useable storage medium as claimed in claim 19 being further configured to perform a first general analysis operation by comparing the product source profiles against the consumer profiles to match the product consumers needing a particular product with the product sources that have the particular product available.
